(19) United States
(12) Patent Application Publication
(10) Pub. No.: US 2019/0297901 A1
(43) Pub. Date: Oct. 3, 2019

(54) Low carbohydrate high protein pizza base

(71) Applicant: Anilkumar Ramanbhai Patel, Jacksonville, FL (US)

(72) Inventor: Anilkumar Ramanbhai Patel, Jacksonville, FL (US)

(21) Appl. No.: 15/932,633

(22) Filed: Mar. 30, 2018

(51) Int. Cl. A21D 13/064; A21D 13/41; A21D 2/26

(52) U.S. Cl. CPC A21D 13/064; A21D 2/265; A21D 2/261; A21D 13/41

(57) ABSTRACT

The subject invention provides unique and novel LOW CARBOHYDRATE HIGH PROTEIN PIZZA BASE. In the first embodiment, said LOW CARBOHYDRATE HIGH PROTEIN PIZZA BASE provides raised, textured pizza base that contain such as but not limited to rice and chicken protein. Other poultry such as but not limited to turkey can be used to replicate said chicken. Uniquely said LOW CARBOHYDRATE HIGH PROTEIN PIZZA BASE is being used as a replacement for traditional high carbohydrate low protein dough used as a pizza base.

### CROSS REFERENCE TO RELATED APPLICATIONS

This application claims the benefit of U.S. Provisional Application No. 62/603,190 filed May 22, 2017, the entire disclosures of which are incorporated herein by reference; and U.S. Trademark Application serial number: 87422314, Mark: PROTEINZA.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### Technical Field

This invention relates generally to the Manual of U.S. Patent Classification definitions technical field of but not limited to as Primary Class 426, FOOD OR EDIBLE MATERIAL: PROCESSES, COMPOSITIONS, AND PRODUCTS; more particularly, to a subclass 657 for protein made from animal material SUCH AS FOWL OR POULTRY. Additional Class/Subclass 426/531 PRODUCTS PER SE, OR PROCESSES OF PREPARING OR TREATING COMPOSITIONS INVOLVING CHEMICAL REACTION BY ADDITION, COMBINING DIVERSE FOOD MATERIAL, OR PERMANENT ADDITIVE and, 426/516 COLLOID SYSTEMS AND WETTING AGENTS.

### Prior Art

While the true originals of pizza may never be know it can be argued that according to many Italians, Italy is where pizza was invented; however, prior to pizza there was a flat bread that the Romans referred to as focaccia. Focaccia is dough from white flour that is baked in the ashes of a hearth until golden brown and topped with olive oil and cheese. Modern pizza dough can be traced to Naples Italy and after adding tomatos to a focaccia in the 18th century, Pizza as it is know today was defined.

Commonly dough is a thick, pliable paste made out of any grain, leguminous or chestnut crops. Said dough is typically a mixture of flour, water and yeast. Flavoring and fats are commonly added to disguise the natural blandness of said ground grains.

Prior art such as U.S. Pat. No.: 5, 441,751; Titled: PRECOOKED PAN PIZZA DOUGH and U.S. Pat. No.: 3,615,679; Titled: FROZEN PIZZA AND DOUGH teach examples of common commercially available flour pizza dough which are wheat or corn flour based. A serving size of one ounce (28 g) of wheat flour, white all-purpose, enriched, bleached flour contains: 102 calories, 21 grams of carbohydrates and 3 grams of protein. A 10″ cheese pizza made with said flour, on average contains 1,000 calories, 127 carbohydrates and 30 grams of protein. Nominally, pizza dough is spread at a ratio of 1 oz of dough to 1″ of pizza. One noted shortcoming of flour based pizza dough is the high percentage of carbohydrates and calories to the low percentage of proteins.

'679 overcome said ratio by using Durum Wheat which is higher in protein but is the hardest species of all wheat. SaId hardness refers to the resistance of the grain to milling, in particular of the starchy endosperm; implying dough made from its flour is weak or “soft”. This makes durum favorable for semolina and pasta and less practical for flour, which requires more work than with hexaploid wheat like common bread wheat. Despite its high protein content, durum is not strong wheat in the sense of giving strength to dough through the formation of a gluten network. Also, durum wheat due to its hardness renders said dough chewy.

Currently there exist reports that 3 million pizzas are sold domestically and 5 million worldwide and the restaurant association reported that one pizza chain sold 12 million pizza slices during the 2017 super bowl and sales continue to increase. Because of the increase in demand of healthier diets consumers are demanding a healthier alternate to flour pizza dough while maintaining the traditional pizza experience. Unfortunately, while the aforementioned patents '751 and '679’ have created unique dough, said dough neither has a traditional flour dough taste or texture nor is considered healthy.

Accordingly, a need remains for LOW CARBOHYDRATE HIGH PROTEIN PIZZA BASE in order to overcome the above-noted shortcomings. The non-limiting exemplary embodiments satisfies such a need by providing a LOW CARBOHYDRATE HIGH PROTEIN PIZZA BASE that is convenient and easy to use, having a high protein percentage and a low carbohydrate percentage as compare to said traditional flour pizza dough nutritional values.

### BRIEF SUMMARY OF THE INVENTION

In view of the foregoing background, it is therefore an object of the non-limiting exemplary embodiments to provide a brief summary on the invention, some of the advantages are: LOW CARBOHYDRATE content, HIGH PROTEIN content while providing traditional pizza dough taste and texture. Another advantage is that said pizza base can be used as a replacement for many flour dough recipes. Said LOW CARBOHYDRATE HIGH PROTEIN PIZZA BASE main protein component is a mixture of rice and poultry in lieu of flour based pizza dough.

Said low carbohydrate high protein pizza base provides a delicious, nutritious, textured medium for a varying array of foods and food stuffs thus meeting the demands for a healthier alternate to flour pizza dough. Embodiments described below demonstrate how said LOW CARBOHYDRATE HIGH PROTEIN PIZZA BASE solves many of the prior art problems.

One embodiment of LOW CARBOHYDRATE HIGH PROTEIN PIZZA BASE is a synergistic blend of protein and carbohydrate from such as but not limited to rice and poultry animal meats that when combined and prepared creates a densely packed, high protein, low calorie and low carbohydrate fuel source for humans or animals.

One embodiment of LOW CARBOHYDRATE HIGH PROTEIN PIZZA BASE is its preferred ovid shape having various sizes; and

An addition embodiment of LOW CARBOHYDRATE HIGH PROTEIN PIZZA BASE is its ability to be delivered prepackaged into wrapped food bars for on-the-go nourishment by athletes or students; and

LOW CARBOHYDRATE HIGH PROTEIN PIZZA BASE is also easy to store and is conveniently sized to cook or prepare one or many; and

LOW CARBOHYDRATE HIGH PROTEIN PIZZA BASE can be prepared by a plurality of heating methods which do not significantly reduce protein or carbohydrate value such as but not limited to microwaves, baked, boiled or freeze dried; and

LOW CARBOHYDRATE HIGH PROTEIN PIZZA BASE can be added to any human or animal fuel source lacking taste and/or texture where an increase of protein is desired; and

LOW CARBOHYDRATE HIGH PROTEIN PIZZA BASE is not affected by altitude.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### PROCESS DESCRIPTION

The beginning stage 1 preparation of LOW CARBOHYDRATE HIGH PROTEIN PIZZA BASE begins with preparation according to said invention by mincing 120 ounces of raw chicken breast to a preferred size in a commercial available mincing tank. Post said stage 1, said minced poultry is held at temperature between 32 and 40 degrees Fahrenheit for no less than 16 hours.

Stage 2 begins when stage 1 is removed from refrigeration and ends when said poultry protein is at room temperature.

Stage 3 begins with stage 1 room temperature product being introduced into 18 ounces of rice and 25 ounces of water and 8 ounces of seasoning and ends when said individual products are thoroughly mixed until a stable colloid state is achieved.

Once said colloid state is attained stage 4 begins as said mixture is contained within plastic bins until virtually no air is contained within said bins and is then held at temperature between 32 and 40 degrees Fahrenheit for 16 hours.

Stage 5 begins once said stage 4 mixtures have reached preferred temperature of 32 degrees and is removed from bins. Once removed from bins said mixture is hand formed into 8 ounce weighed sphere shapes and returned to bins for refrigeration.

Once a bin full has been pre-rolled stage 6 begins. At stage 6, said 8 ounce balls are placed one at a time inside a preferred diameter ovid mold, nominally 10″, and pressed by mechanical device which exerts 120 lbs for 2 seconds to form an ovid shape having a jagged perimeter edge.

In Stage 7 said shapes are restacked sandwiching a separation sheet to avoid said pressed shapes forming together. Post said stage 7, LOW CARBOHYDRATE HIGH PROTEIN PIZZA BASE is immediately cooked or shelved for later use.

### NUTRITIONAL INFORMATION

In comparing the various flour/wheat pizza dough bases available such as but not limited to said patents '751 and '679 to the subject invention, the function of holding toppings is the similar; however, three unique difference separate the aforementioned '751 and '679 and said LOW CARBOHYDRATE HIGH PROTEIN PIZZA BASE is the nutritional value. Pizzas produced according to the subject invention are lower in calories and carbohydrates and higher in protein.

A typical 10″ cheese pizza made with said flour dough of '751 or '679, on average contain: 1,000 calories, 127 grams carbohydrates and 30 grams of protein. Alternately, said LOW CARBOHYDRATE HIGH PROTEIN PIZZA BASE contains 344 calories, 13 grams of carbohydrate and 54 grams of protein. This gives way to LOW CARBOHYDRATE HIGH PROTEIN PIZZA BASE being a significantly advantageous food for muscle growth or when a high protein low carbohydrate diet is prescribed or desired.

### FAST FOOD, QUICK SERVICE, DINING SAFETY HAZARDS AND SAFETY EVALUATION

Said pizza base of the subject invention (also known as PROTEINZA) should be stored at a temperature lower than 40 degrees Fahrenheit. Said pizza base can be served hot, warm or cold without concern of bacteria or microorganisms provided storage temperatures remain below 40 degrees. Once ready to use, from frozen or immediate post said stage 8 they can be prepared by a plurality of heating methods which do not significantly reduce protein or carbohydrate value such as but not limited to microwaves, baked, boiled or freeze dried.

Once consumed, any leftovers should immediately be brought to a temperature below 40 degrees.

### COMPETITIVE FRAMEWORK

In one example, a pizza crust version of SAID LOW CARBOHYDRATE HIGH PROTEIN PIZZA BASE can be used by quick serve restaurants, fast food chains and both independent and chain pizzerias such as but not limited to Domino's, Pizza Hut and Little Caesars. Said restaurants could integrate said pizza crust version of LOW CARBOHYDRATE HIGH PROTEIN PIZZA BASE with neither additional equipment nor ingredients; thereby providing a healthy option and new concept to a traditionally high calorie and carbohydrate food.

Another scope for revolutionizing traditional fast food restaurants such as McDonald's, Chick-fil-a and Wendy's, whereby they can incorporate LOW CARBOHYDRATE HIGH PROTEIN PIZZA BASE alongside their everyday menu by substituting carbohydrate, calorie and fat rich items with LOW CARBOHYDRATE HIGH PROTEIN PIZZA BASE.

LOW CARBOHYDRATE HIGH PROTEIN PIZZA BASE is versatile in that the ingredients only need to be changed slightly in proportion or prepared in a different way to create a number of high protein goods. For example snacks such as but not limited to chips and bars, substitutes for foods such as spaghetti, pasta, tortillas, tacos, bread and biscuits. The goods can be fortified with vitamins, minerals and other supplements to provide further nutritional value while neither compromising the texture, nor taste or binding.

Consumers today are far more conscious of their health, nutrition and fitness. Said consumers take time to understand diets and nutrition and have increasing amounts of knowledge in this domain. There is a trend towards healthier, lighter, lower calorie, low carbohydrate menu items that is also similar to the unhealthy fast food that they are used to. There is also a trend towards higher protein intake, with evidence that the normal American diet is lacking enough protein intake.

A pizza crust version of LOW CARBOHYDRATE HIGH PROTEIN PIZZA BASE has a high protein content surpassing the recommended daily allowance tor a sedentary man or woman of average weight. Having a high protein intake has been proven to increase satiety (Westerterp-Plantenga, M., Lemmens, S., & Westerterp, K. (2012). Dietary protein—its role in satiety, energetics, weight loss and health. British Journal of Nutrition, 108(S2), S105-S112. doi:10.1017/50007114512002589; and Douglas Paddon-Jones, Eric Westman, Richard D Mattes, Robert R Wolfe, Arne Astrup, Margriet Westerterp-Plantenga; Protein, weight management, and satiety, The American Journal of Clinical Nutrition, Volume 87, Issue 5, 1 May 2008, Pages 1558S-1561S, https://doi.org/10.1093/ajcn/87.5.1558S), recovery from injury and muscle mass (Denise K Houston, Barbara J Nicklas, Jingzhong Ding, Tamara B Harris, Frances A Tylaysky, Anne B Newman, Jung Sun Lee, Nadine R Sahyoun, Marjolein Visser, Stephen B Kritchevsky, ; Dietary protein intake is associated with lean mass change in older, community-dwelling adults: the Health, Aging, and Body Composition (Health ABC) Study, The American Journal of Clinical Nutrition, Volume 87, Issue 1, 1 January 2008, Pages 150-155, https://doi.org/10.1093/ajcn/87.1.150)

There is also improved insulin control [Mary C Gannon, Frank Q Nuttall, Asad Saeed, Kelly Jordan, Heidi Hoover; An increase in dietary protein improves the blood glucose response in persons with type 2 diabetes, The American Journal of Clinical Nutrition, Volume 78, Issue 4, 1 October 2003, Pages 734-741, https://doi.org/10.1093/ajcn/78.4.734) and weight management with high protein intake (Douglas Paddon-Jones, Eric Westman, Richard D Mattes, Robert R Wolfe, Arne Astrup, Margriet Westerterp-Plantenga; Protein, weight management, and satiety, The American Journal of Clinical Nutrition, Volume 87, Issue 5, 1 May 2008, Pages 1558S-1561S, https://doi.org/10.1093/ajcn/87.5.15585)

The pizza crust version of LOW CARBOHYDRATE HIGH PROTEIN PIZZA BASE is therefore healthier than regular pizza crusts and can be used in the same way as a regular pizza crust with whichever toppings that are desired to create a healthier version. There is also a trend towards gluten free products with many individuals suffering from celiac disease or intolerance to gluten. LOW CARBOHYDRATE HIGH PROTEIN PIZZA BASE is inherently gluten free thereby creating not only a high protein, low carbohydrate and lower calorie version of many foods but also a gluten free version.

As used herein the term “seasoning” refers to ingredients that add an additional layer of flavor to the invention. From herein the use of “chicken” as the main component for the subject invention is interchangeable with any protein source however in particular animal protein including but not limited to chicken, lamb, beef, pork and fish. All percentages are by weight and all solvent mixture proportions are by volume unless otherwise noted.

In the subject invention's embodiments—for example the protein pizza crust, bars, chips etc. versions of the subject invention are available to individual consumers for home use via sales in retail stores such as grocery stores, gourmet food boutiques, restaurants and convenience stores. In certain embodiments the subject invention can also be frozen prior to usage thereby giving it a long shelf life. There is also potential for adding stabilizers and preservatives to certain embodiments of the invention thereby allowing it to be stored and eaten after long periods without cooling.

Following are Example 1, Ingredient Formulation; showing preferred ingredients of and nutritional value of said LOW CARBOHYDRATE HIGH PROTEIN PIZZA BASE. All percentages are by weight and all mixture proportions are by volume unless otherwise noted.

### EXAMPLE 1

### Low Carbohydrate High Protein Pizza Base Ingredient Formulation

| Ingredient | % | Function |
|---|---|---|
| Chicken | 73.25 | Main component for structure, protein and |
| | | bulk, flavor and mouthfeel |
| Brown rice powder | 11 | Secondary component for structure, bulk, |
| | | binding, flavor and mouthfeel. |
| Water | 15.25 | Solvent |
| Seasoning, (e.g. salt, | 0.5 | Flavor |
| Spice, blends) | | |

Following are non-limiting Examples 2, 3 and 4 are various recipes which can be created, and nutritional value such as but not limited to: Floridian Feast, Miami Mandarin and Texas Tangy BBQ. LOW CARBOHYDRATE HIGH PROTEIN PIZZA BASE is sold commercially in bulk packaging; however, could be scaled down for the individual consumer to prepare in home.

### EXAMPLE 2

### Floridian Feast Recipe

| Floridian Feast | Ounces |
|---|---|
| Pepperoni | 0.38 |
| Cooked beef | 0.63 |
| Cooked Ham | 0.88 |
| Sausage | 1⅛ oz |
| Bacon topping | 0.98 |
| Mozzarella cheese | 1.25 |
| Pizza sauce | 2 |
| Floridian Feast Full 10″ Proteinza pizza nutrition | |
| Calories | 819 |
| Protein | 90 g |
| Carbohydrates | 20 g |
| Fiber | 2 g |
| Sugar | 2 g |
| Fat | 39 g |
| Saturated fat | 25 g |
| Polyunsaturated fat | 1 g |
| Monounsaturated fat | 4 g |
| Trans fat | 0 g |
| Cholesterol | 250 mg |
| Sodium | 2119 mg |
| Potassium | 671 mg |
| Vitamin A | 16% |
| Vitamin C | 13% |
| Calcium | 36% |
| Iron | 18% |

### EXAMPLE 3

### Miami Mandarin Recipe

| Miami Mandarin | Ounces |
|---|---|
| Feta cheese | 1 |
| Grilled chicken | 2.63 |
| Ricotta cheese | 1.38 |
| Red onion | 0.75 |
| Balsamic glaze | 0.25 |
| Spring mix baby greens | 0.5 |
| Vinaigrette | 0.13 |
| Mandarin oranges | 3 |
| Miami Mandarin Full 10″ Proteinza pizza nutrition | |
| Calories | 599 |
| Protein | 77 g |
| Carbohydrates | 40 g |
| Fiber | 1 g |
| Sugar | 12 g |
| Fat | 18 g |
| Saturated fat | 9 g |
| Polyunsaturated fat | 2 g |
| Monounsaturated fat | 4 g |
| Trans fat | 0 g |
| Cholesterol | 203 mg |
| Sodium | 778 mg |
| Potassium | 616 mg |
| Vitamin A | 4% |
| Vitamin C | 9% |
| Calcium | 21% |
| Iron | 16% |

### EXAMPLE 4

### Texas Tangy BBQ Recipe

| Texas Tangy BBQ Recipe | Ounces |
|---|---|
| Mozzarella cheese | 1.25 |
| Red onion | 0.75 |
| Grilled chicken | 2.63 |
| BBQ sauce | 1.87 |
| Texas Tangy BBQ | |
| Full 10″ Proteinza pizza nutrition | |
| Calories | 607 |
| Protein | 80 g |
| Carbohydrates | 18 g |
| Fiber | 2 g |
| Sugar | 2 g |
| Fat | 17 g |
| Saturated fat | 7 g |
| Polyunsaturated fat | 1 g |
| Monounsaturated fat | 5 g |
| Trans fat | 0 g |
| Cholesterol | 201 mg |
| Sodium | 705 mg |
| Potassium | 552 mg |
| Vitamin A | 6% |
| Vitamin C | 1% |
| Calcium | 36% |
| Iron | 14% |

One or more embodiments of the disclosure may be referred to herein, individually and/or collectively, by the term “non-limiting exemplary embodiments” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the non-limiting exemplary embodiments. Thus, to the maximum extent allowed by law, the scope of the non-limiting exemplary embodiments is to be determined by the broadest permissible interpretation of the following claims and their equivalents, and shall not be restricted or limited by the foregoing detailed description.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “non-limiting exemplary embodiment” in various places in the specification are not necessarily all meant to refer to the same embodiment.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the non-limiting exemplary embodiments may include variations in size, materials, shape, form, function and manner of operation.

What is claimed as new and what is desired to secure by Letters Patent of the United States is:

1. A low carbohydrate high protein pizza base comprising at least 58% poultry animal protein and at least 1% rice protein and less then 7 grams of fat by weight in 8 ounces of LOW CARBOHYDRATE HIGH PROTEIN PIZZA BASE; wherein said LOW CARBOHYDRATE HIGH PROTEIN PIZZA BASE is sufficiently ridgid to support toppings without folding; and wherein said LOW CARBOHYDRATE HIGH PROTEIN PIZZA BASE is a gelled liquid.

2. The LOW CARBOHYDRATE HIGH PROTEIN PIZZA BASE according to claim 1, wherein the animal protein is a selection of chicken, lamb, beef, pork or fish.

3. The LOW CARBOHYDRATE HIGH PROTEIN PIZZA BASE, according to claim 1, wherein the LOW CARBOHYDRATE HIGH PROTEIN PIZZA BASE is ovid shaped having a jagged perimeter edge.

3. The LOW CARBOHYDRATE HIGH PROTEIN PIZZA BASE, according to claim 3, wherein the diameter of the LOW CARBOHYDRATE HIGH PROTEIN PIZZA BASE is from 10 inches to 18 inches.

4. The LOW CARBOHYDRATE HIGH PROTEIN PIZZA BASE, according to claim 3, wherein the thickness of The LOW CARBOHYDRATE HIGH PROTEIN PIZZA BASE is ¼ inch to ⅜ inch.

5. The LOW CARBOHYDRATE HIGH PROTEIN PIZZA BASE, according to claim 1, wherein the weight of LOW CARBOHYDRATE HIGH PROTEIN PIZZA BASE is from 8 ounces for 10″ or 14 ounces for 18″.

6. The LOW CARBOHYDRATE HIGH PROTEIN PIZZA BASE, according to claim 1, further comprising: a) a flavor amplifier and preservative.

7. The LOW CARBOHYDRATE HIGH PROTEIN PIZZA BASE, according to claim 7, does not contain a sweetening agent.

8. The LOW CARBOHYDRATE HIGH PROTEIN PIZZA BASE, according to claim 7, wherein said flavor amplifier is selected from: salt, parsley, garlic, onion, canola oil, buttermilk or vinegar.

10. The LOW CARBOHYDRATE HIGH PROTEIN PIZZA BASE, produced according to the following steps:
a) mincing 120 ounces of raw chicken breast to a preferred size in a commercial available mincing tank; and bringing the temperature between 32 and 40 degrees Fahrenheit for no less than 16 hours; and
b) introducing 18 ounces of rice and 25 ounces of water and 8 ounces of seasoning and thoroughly mixing until a stable colloid state is achieved; and
c) containment within plastic bins until virtually no air is contained within said bins and held at temperature between 32 and 40 degrees Fahrenheit for 16 hours; and
d) form by hand into 8 ounce weighed sphere shapes and returned to bins and hold temperature between 32 and 40 degrees Fahrenheit; and
e) place one at a time inside a preferred diameter circle mold, nominally 10″, and pressed by mechanical device which exerts 120 lbs for 2 seconds to from an ovid shape having a jagged perimeter edge; and
f) Heat by a method until the colloid mixture form a LOW CARBOHYDRATE HIGH PROTEIN PIZZA BASE of claim 1.
